(19) United States
(12) Patent Application Publication
(10) Pub. No.: US 2013/0021923 A1
(43) Pub. Date: Jan. 24, 2013

(54) COMMUNICATION DROP AVOIDANCE VIA SELECTIVE MEASUREMENT REPORT DATA REDUCTION

(71) Applicants: Wililam K. Morgan, Wauconda, IL (US); Daniel C. Chisu, Franklin Park, IL (US)

(72) Inventors: Wililam K. Morgan, Wauconda, IL (US); Daniel C. Chisu, Franklin Park, IL (US)

(73) Assignee: Motorola Mobility, Inc., Libertyville, IL (US)

(21) Appl. No.: 13/184,838

(22) Filed: Jul. 18, 2011

(51) Int. Cl. H04W 36/30; H04W 24/10

(52) U.S. Cl. 370/252; 370/328; 370/332

(57) ABSTRACT

Mitigating a risk of a communication session being dropped while the communication session is in progress. Conventional measurement report (MR) messages can be generated and communicated from a mobile communication device to a communication network. Responsive to the mobile communication device detecting an out-of-sync (OOS) condition, an OOS counter can be incremented. When the OOS counter is equal to at least a threshold value, generation of conventional MR messages can cease. Further, at least one size reduced MR message can be generated. An amount of data contained in the size reduced MR message can be selectively limited to be less than an amount of data contained in the conventional MR messages. The size reduced MR message can be communicated from the mobile communication device to the communication network.

### BACKGROUND OF THE INVENTION

1. Field of the Invention

The present invention generally relates to mobile communications and, more particularly, to communication handoff in a mobile communication system.

2. Background of the Invention

It is typical for a mobile communication device to handoff from one communication network wireless access node to another when moving. For example, a mobile communication device may handoff from one base transceiver station (BTS) to another BTS. When a handoff is to occur, messages typically are communicated between the mobile communication device and the network. For example, in certain protocols, such as Wideband Code Division Multiple Access (WCDMA) and Long Term Evolution (LTE), the mobile communication device may communicate to the network measurement report messages containing information about BTSs to which the mobile communication device potentially may handoff. Based at least in part on these messages, a new BTS is selected to receive the handoff.

### SUMMARY OF THE INVENTION

The present invention relates to a method of mitigating a risk of a communication session being dropped while the communication session is in progress. The method can include generating conventional measurement report (MR) messages and communicating from a mobile communication device to a communication network the conventional MR messages. Responsive to the mobile communication device detecting an out-of-sync (OOS) condition, an OOS counter can be incremented. When the OOS counter is equal to at least a threshold value, generation of conventional MR messages can cease. Further, at least one size reduced MR message can be generated. An amount of data contained in the size reduced MR message can be selectively limited to be less than an amount of data contained in the conventional MR messages. The size reduced MR message can be communicated from the mobile communication device to the communication network.

Another embodiment of the present invention relates to a mobile communication device. The mobile communication device can include a transceiver and a processor. The processor can be configured to generate conventional measurement report (MR) messages and, via the transceiver, communicate the conventional MR messages to a communication network. Responsive to detecting an out-of-sync (OOS) condition between the mobile communication device and the communication network, the processor can increment an OOS counter. When the OOS counter is equal to at least a threshold value, the processor can cease generation of the conventional MR messages and generate at least one size reduced MR message, wherein an amount of data contained in the size reduced MR message is selectively limited to be less than an amount of data contained in the conventional MR messages. Further, via the transceiver, the processor can communicate the size reduced MR message to the communication network.

Yet another embodiment of the present invention can include a machine-readable storage device having stored thereon machine-readable program code that, when executed, causes a machine to perform the various steps and/or functions described herein.

### BRIEF DESCRIPTION OF THE DRAWINGS

Preferred embodiments of the present invention will be described below in more detail, with reference to the accompanying drawings, in which:

FIG. 1 depicts a communication network and communication device that are useful for understanding the present invention;

FIG. 2A is a flowchart illustrating a method of mitigating a risk of communication session drop that is useful for understanding the present invention;

FIG. 2B is a continuation of the flowchart of FIG. 2A illustrating a method of mitigating a risk of communication session drop that is useful for understanding the present invention;

FIG. 2C is a continuation of the flowchart of FIG. 2A illustrating a method of mitigating a risk of communication session drop that is useful for understanding the present invention; and

FIG. 3 depicts a block diagram of a communication device that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Arrangements described herein relate to mitigating a risk of communication session being dropped while communication session is in progress. More particularly, conventional measurement report (MR) messages can be communicated from a mobile communication device (hereinafter “communication device”) to a communication network. The MR messages can contain information about which cells are potential wireless access node targets to receive handoff of the communication device. When the communication device's out-of-sync counter reaches a threshold which is configured to be less than the out-of-sync threshold received from the communication network, thus indicating that the communication device is close to experiencing a communication drop, the communication device can limit the size of the MR messages communicated to the network.

In illustration, the size of the MR messages can be limited by identifying in the MR messages only those wireless access nodes having a highest likelihood of receiving the handoff. Because the size reduced MR messages are smaller than typical MR messages, the size reduced MR messages can be communicated in less time (particularly in an error prone environment using Automatic Repeat reQuest protocol), thereby reducing the risk of the communication session being dropped. Accordingly, implementation of the present invention can improve dropped communication session rates in the communication network.

The communication session can be a data communication session, an audio communication session (e.g., a call session), a video communication session, or an audio video communication session. The communication session may be established between two or more entities. An entity may be a person (e.g., a human being), though this need not be the case. For example, a communication session may be established between two persons, between a person and an automated entity (e.g., a communication handling system), or between two automated entities.

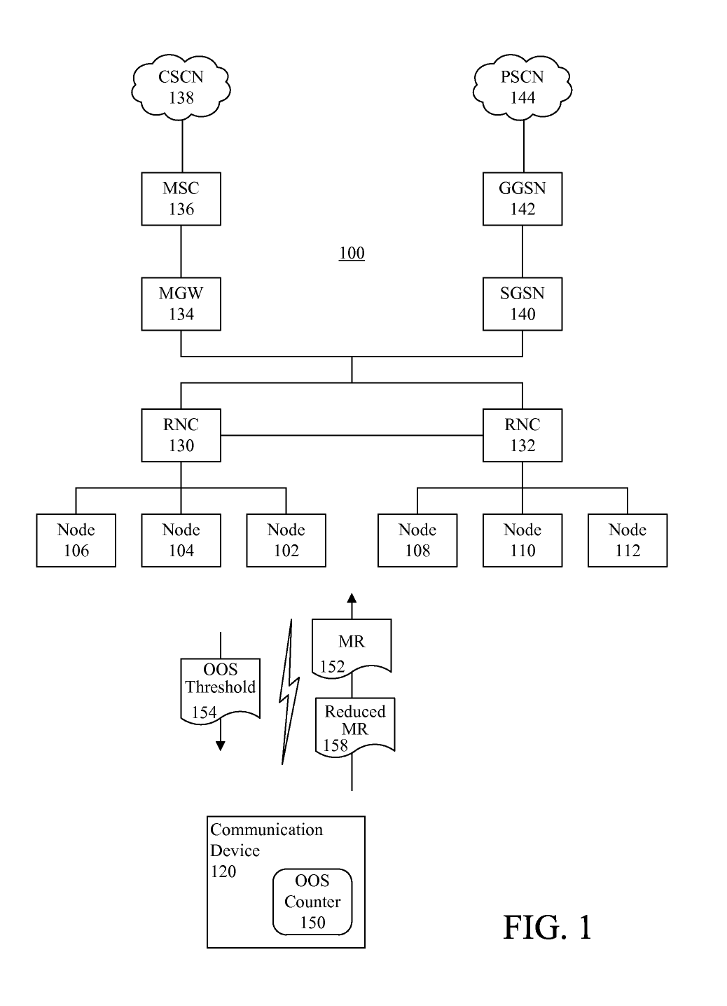

FIG. 1 depicts a communication network 100 that is useful for understanding the present invention. The communication network 100 can include a plurality of wireless access nodes (hereinafter “nodes”) 102, 104, 106, 108, 110, 112. The nodes can be base station transceivers, repeaters, WiFi® access points, or any other nodes that wirelessly connect a wireless communication device (hereinafter “communication device”) 120 to the communication network 100. As such, each node 102-112 can comprise one or more antenna elements and one or more components for transmitting and receiving RF signals (e.g., transceivers). As known to those skilled in the art, each node 102-112 also may include any of a myriad of other suitable components, for instance network adapters, communication ports, controllers, and so on, but the invention is not limited in this regard.

The nodes 102-112 can communicate with the communication device 120 via wireless communications, and implement any of a myriad of suitable radio access technologies. Examples of such radio access technologies include, but are not limited to, WCDMA, CDMA 1×, WiMAX, LTE, etc. Still, the invention is not limited in this regard and the system can be configured to communicate RF signals in accordance with any suitable communications standards, protocols, and/or architectures, or a suitable combination of such standards, protocols, and/or architectures.

The communication device 120 can be a mobile station, a mobile telephone, a mobile radio, a personal digital assistant, a computer, a mobile computer, a tablet computer, a mobile terminal, an application specific device, or any other mobile device that can transmit and/or receive wireless communication signals.

The communication network 100 further can include any of a variety of network resources. In illustration, the communication network 100 can include one or more radio network controllers (RNCs) 130, 132. The RNCs 130, 132 can interface with the nodes 102-112 to implement radio resource management and mobility management functions in the communication network 100. The RNCs 130, 132 further can provide communication links between the communication device 120 and a circuit switched communication network (CSCN) 138. For example, the RNCs 130, 132 can communicatively link the nodes 102-112 to a mobile switching center (MSC) 136 via a media gateway (MGW) 134, which interfaces with the CSCN 138. The RNCs 130, 132 also can provide communication links between the communication device 120 and a packet switched communication network (PSCN) 144. For example, the RNCs 130, 132 can communicatively link the nodes 102-112 to a gateway GPRS support node (GGSN) 142 via a serving GPRS support node (SGSN) 140, which interfaces with the PSCN 144. The basic operation of RNCs, MGWs, MSCs, SGSNs and GGSNs are well known to those skilled in the art.

In operation, the communication device 120 can be communicatively linked to at least one of the nodes 102-112. For example, the communication device 120 can be communicatively linked to the node 102. In this regard, a communication session can be established on the communication device 120 via the node 102. When the communication session is established, the communication device 120 can set an OOS counter 150 implemented by the communication device to zero, or any other desired value. During the communication session, the communication device 120 can communicate MR messages 152 to the communication network 100, for example to the RNC 130, according to reporting criteria. Such criteria can specify that the MR messages 152 are to be communicated periodically and/or in response to the occurrence of certain events. When the MR messages 152 are communicated periodically, the period can be predefined, though this need not be the case. An example of an event that triggers the sending of an MR message 152 is a determination that a signal strength, as measured by the communication device 120, has reached a certain level for a certain amount of time. In illustration, when the communication device 120 detects that the signal strength from a node 104-112, as measured at the communication device 120, has reached a particular threshold value for a threshold amount of time, the sending of an MR message 152 can be triggered. The MR message 152 can inform the network 100 (e.g., the RNC 130) that such event has occurred. Accordingly, the RNC 130 can identify the node corresponding to the measured signal as a node that potentially may receive handoff of the communication device 120 when handoff is to occur.

The MR messages 152 can include a variety of information reported from the communication device 120 to the communication network 100 (e.g., to the RNC 130). For example, certain types of MR messages 152 can include various measurements related to the communication link between the communication device 120 and the node 102. In illustration, the MR messages 152 can include measurements on downlink physical channels, measurements on uplink traffic volume, quality measurements, internal measurements (e.g., the communication device transmission power and received signal level), and measurements for location services. Data corresponding to the measurements can be associated with the node 102 within the MR messages 152. For example, an identifier corresponding to the node 102 can be associated with the data.

Certain MR messages 152, such as event 1A (E1A) messages in WCDMA (as defined in 3GPP TS (Third Generation Partnership Project Technical Specification) 25.331), can include various measurements related to communication links between the communication device 120 and other nodes, for instance nodes 104-112, which are potential candidates to receive handoff of the communication device 120 from the node 102. For example, the communication device 120 can measure nodes 104-112 signal attributes at its receiver to, among other things, gather measurements related to the communication links between the communication device 120 and the respective node nodes 104-112. The E1A message can indicate to the communication network 100, for example to the RNC 130, which node 104-112 to which each set of data corresponds. Other radio specifications use MRs similar to E1A messages, and such other messages are within the intended scope of the present invention.

Other MR messages 152, such as event 1C (E1C) messages in WDCMA (as defined in 3GPP TS 25.331), can indicate to the communication network 100 (e.g., to the RNC 130), a change in which nodes 104-112 are determined by the communication device 120 to be valid candidates to receive handoff of the communication device 120. The determination can be based on the measurements gathered by the communication device 120 of the nodes 104-112. In response to an E1C message, the network 100 can prepare to handoff the communication device 120 to a node 104-112 identified in the E1C message, while dropping another node 104-112 with which the communication device 120 currently is in handoff. Other radio specifications use messages similar to E1C messages, and such other messages are within the intended scope of the present invention, as the specific message employed is not critical to the present invention. For example, in various other embodiments of the present invention, the MR message may be a Pilot Strength Measurement Message (PSMM) (in CMDA 1×), a Route Update message (CDMA EVDO), or an event A1 or A5 message (3GPP LTE).

When an OOS condition is detected by the communication device 120 during the communication session, the communication device 120 can increment the OOS counter 150. In one arrangement, when an in-sync condition is detected by the communication device 120 during the communication session, the communication device 120 can decrement the OOS counter 150.

When the OOS counter 150 reaches a threshold value, the communication device 120 can enter a communication recovery mode. When a MR event is triggered during the communication device recovery mode, for instance an event that triggers an E1A or E1C message report, the communication device 120 can cease generating conventional MR messages 152, and instead begin generating and communicating size reduced MR messages 158 to the communication network 100. The threshold value can be less than a value that triggers the communication session to be dropped. For example, in WCDMA and LTE, the value that triggers the communication session to be dropped can be a “successive out-of-sync reception max” (N313) value, although other radio specifications may use other values. Moreover, other parameters may be communicated to the communication device 120, and the invention is not limited in this regard. By way of example, the N313 value can be set to any desired value, for example 2, 4, 10, 20, 50, 100, 200, etc. The threshold value can be less than the N313 value. For instance, if the N313 value is set to 100, the threshold value can be set to 30, 50, 80, or any other desired value less than 100. In one arrangement, the threshold value can be set to be a percentage of the N313 value.

The amount of data contained in the size reduced MR messages 158 can be selectively limited to be less than an amount of data contained in the conventional MR messages 152. For example, rather than including measurement data for each of the nodes 102-112, the size reduced MR messages 158 can include measurement data for a reduced number of nodes. In illustration, the size reduced MR messages 158 can include certain measurement data sorted from other measurement data in accordance with the 3GPP TS 25.331.

In illustration, when one or more E1A messages are to be sent (e.g., in accordance with the WCDMA or LTE protocols), the size reduced MR messages 158 can be limited to include only the measurement data corresponding to the node or nodes having a highest likelihood of receiving handoff of the communication device 120 from the node 102. For example, if nodes 104 and 108 have the highest likelihood of receiving the handoff, the size reduced MR messages 158 can include measurement data corresponding to the nodes 104 and 108, while excluding measurement data corresponding to the nodes 106, 110, and 112. It should be noted, however, that the communication device 120 need not stop collecting measurement data corresponding to the nodes 106, 110, and 112; it simply does not need to report such measurement data.

In another example, when one or more E1C messages are to be sent (e.g., in accordance with the WCDMA or LTE protocols), the MR messages 158 can be limited to only indicate the node or nodes having a highest likelihood of receiving handoff of the communication device 120 from the node 102. For example, the MR messages 158 can indicate the nodes 104, 108, while excluding the nodes 106, 110, 112.

The selection of the nodes 104, 108 by the communication device 120 to include in the size reduced MR messages 158, and the nodes 106, 110, 112 to exclude from the size reduced MR messages 158, can be based on any suitable measurement criteria. The measurement criteria can be based on, for example, measurements such as signal strength, noise level, signal-to-noise ratio (SNR), jitter, latency, communication rate, and/or communication quality associated with communication links between the communication device 120 and the respective nodes 104-112. Still, other measurement criteria can be measured and the invention is not limited in this regard. Such measurements can be made by the communication device 120.

In one arrangement, the measurement criteria can specify one or more measurement threshold values. If the measurement (or measurements) for a particular node 104-112 at least meets the criteria, the communication device 120 can include the node in the size reduced MR messages 158. If the measurement (or one or more of the measurements) for a particular node 104-112 do not meet the criteria, the communication device 120 can exclude the node from the size reduced MR messages 158.

In another arrangement, the communication device 120 can rank the nodes 104-112 according to the measurements. Again, the measurements can include signal strength, noise level, signal-to-noise ratio (SNR), jitter, latency, communication rate and/or communication quality associated with communication links between the communication device 120 and the respective nodes 104-112. Still, other measurements can be measured and the invention is not limited in this regard.

Nodes 104-112 having the highest rankings can be selected by the communication device 120 to be included in the size reduced MR messages 158, and nodes 104-112 not having the highest rankings can be selected by the communication device 120 to be excluded in the size reduced MR messages 158. In one aspect of the present arrangements, the communication device 120 can select a particular number of highest ranking nodes to be included in the size reduced MR messages 158. Specifically, information, such as identifiers and data, corresponding to the highest ranking nodes can be included in the size reduced MR messages 158. For example, the communication device 120 can select a single highest ranking node, the top two highest ranking nodes, the top three highest ranking nodes, the top four highest ranking nodes, and so on. In another embodiment of the present invention, the communication device 120 can select which nodes to be include in the size reduced MR messages 158 based on comparisons of a measured communication link condition, such as a signal strength, noise level, signal-to-noise ratio (SNR), jitter, latency, communication rate, and/or communication quality, associated with each such node to a corresponding measured communication link condition threshold maintained by a machine-readable storage device of the communication device, wherein the communication device includes, in the size reduced MR messages 158, nodes whose measured communication link condition is at least equal to the corresponding communication link condition threshold and excludes from the size reduced MR messages 158 nodes whose measured communication link condition is less than the corresponding communication link condition threshold. Nodes 104-112 that are not the highest ranking nodes can be excluded from the size reduced MR messages 158. For instance, information, such as identifiers and data, corresponding to such nodes can be excluded from the size reduced MR messages 158.

Advantageously, use of the size reduced MR messages 158, as well as limiting the number of radio link control (RLC) polling and overhead control messages, can reduce the amount of time it takes to initiate handoff of the communication device 120 from the node 102 to another node, such as node 104 or node 108. By way of example, in WCDMA and LTE, a radio resource control (RRC) layer (layer 3) can pass report messages to a RLC layer (layer 2). These report messages typically contain the measurement data previously described corresponding to the respective nodes 102-112. The RLC layer generally parses the messages into multiple payload data units (PDUs). Thus, larger report messages require a greater number of PDUs in comparison to smaller report messages.

Further, RLC can include an automatic repeat request (ARQ)-based retransmit mechanism for the polling and overhead control messages. When fewer RLC polling and overhead control messages are transmitted, the delay for processing such messages is reduced. Such delay includes not only over the air delay, but also ACK/NACK feedback delay associated with RLC polling timers.

When RF conditions are poor, the probability of successfully transmitting any one PDU in a single transmission decreases, and thus the likelihood of a retransmission of the PDU being required increases. For layer 3 messages that result in multiple PDUs the effect becomes more pronounced. Moreover, a layer 3 message destined to be communicated to the RNC 130 via the node 102 cannot be processed by the node 102 until all of the associated PDUs have been successfully received. The number of transmissions and retransmissions, and hence the time required to process the message, are proportional to the number of PDUs comprised by the message. By implementing the size reduced MR messages 158, the present invention mitigates the risk of the communication session being dropped before the handoff is completed, thereby improving dropped communication rates in the communication network 100.

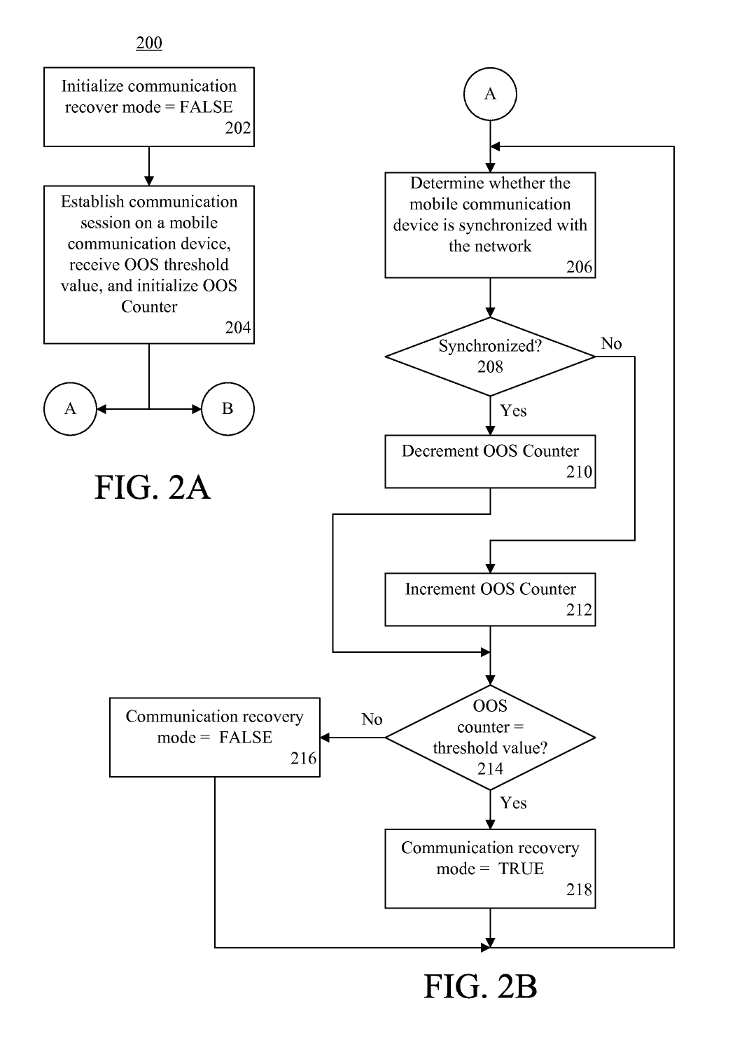

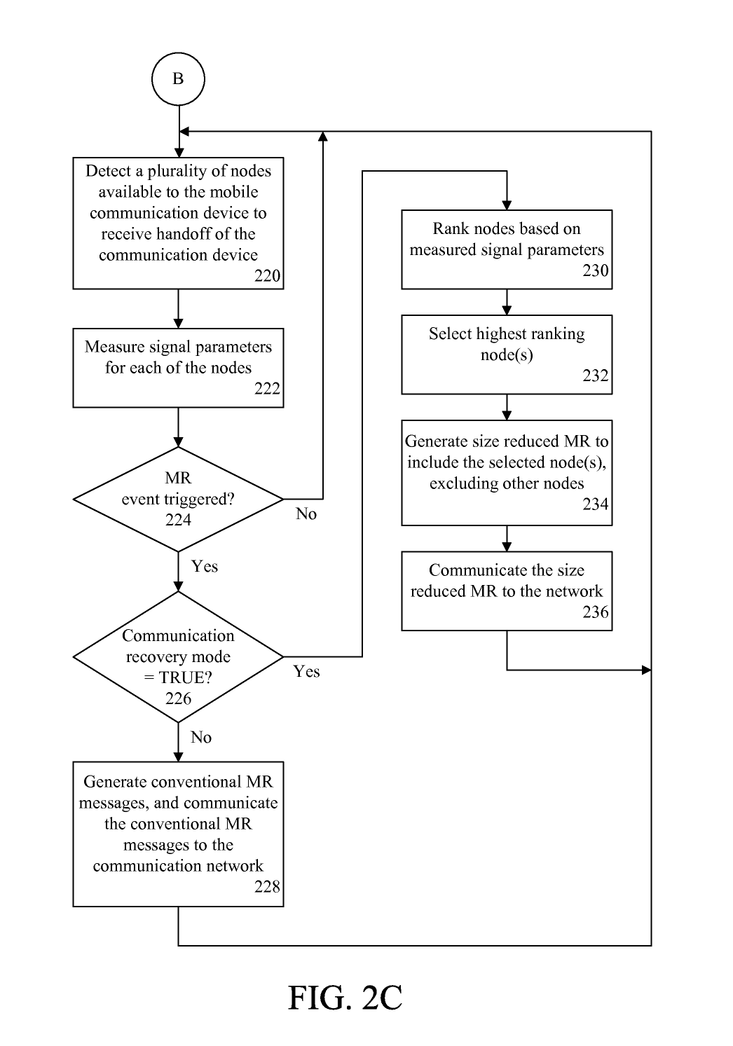

FIGS. 2A-2C depict a flowchart illustrating a method 200 of mitigating a risk of communication session drop that is useful for understanding the present invention. Referring first to FIG. 2A, at step 202 a communication recovery mode can be initialized to be FALSE. At step 204 a communication session can be established on a communication device, such as communication device 120, and the communication device can receive an OOS threshold value from a communication network, such as network 100, for example, from an RNC, such as RNC 130. Further, an OOS counter on the communication device can be initialized. For example, the OOS counter can be initialized to a value of zero.

The process can proceed to step 206 of FIG. 2B and/or to step 220 of FIG. 2C. FIG. 2B pertains to synchronization processing by the communication device, and FIG. 2C pertains to MR processing by the communication device. Such processes can run concurrently.

Referring now to FIG. 2B, at step 206 the communication device can determine whether it is synchronized with the communication network. At decision box 208, if the communication device is synchronized with the communication network, at step 210 the OOS counter can be decremented. If the OOS counter already was at a value of zero, then the OOS counter need not be decremented below that value. If the communication device is not synchronized with the communication network, at step 212 the OOS counter can be incremented.

At decision box 214, a determination can be made whether the OOS counter at least equals a threshold value. If not, at step 216 a communication recovery mode flag can be set to FALSE. If the communication device was in communication previously was in recovery mode, the communication device can be removed from the communication recovery mode. If at decision box 214 a determination is made that the OOS counter at least equals the threshold value, at step 218 the communication recovery mode flag can be set to TRUE. Accordingly, the communication device can enter communication recovery mode for the current communication session. Regardless of whether the communication recovery mode flag is set to TRUE or FALSE, the process can return to step 206 and synchronization processing by the communication device can continue.

Referring now to FIG. 2C, at step 220 the communication device can detect a plurality of wireless communication nodes, such as nodes 104-112, available to the mobile communication device to receive handoff of the communication device. At step 222, the communication device can measure signal parameters for each of the nodes. At decision box 224, a determination can be made as to whether a MR event is triggered. For example, a determination can be made as to whether an E1A or E1C MR message is to be generated. If a MR event is not triggered, the process can return to step 220.

If at decision box 224 a determination is made that a MR event is triggered, the process can proceed to decision box 226, and a determination can be made whether the communication recovery mode flag is set to TRUE. If not, at step 228, the communication device can generate conventional MR messages, and communicate the conventional MR messages to the communication network. The process then can proceed to step 220.

If at decision box 226 a determination is made that the communication recovery mode flag is set to TRUE, then at step 230 nodes of the communication network can be ranked based on the measured signal parameters. At step 232 one or more of the highest ranking nodes can be selected. At step 234, a size reduced MR can be generated to include information corresponding to the selected node(s), while excluding other detected nodes. At step 236 the size reduced MR message can be communicated from the communication device to the communication network. The process then can return to step 220.

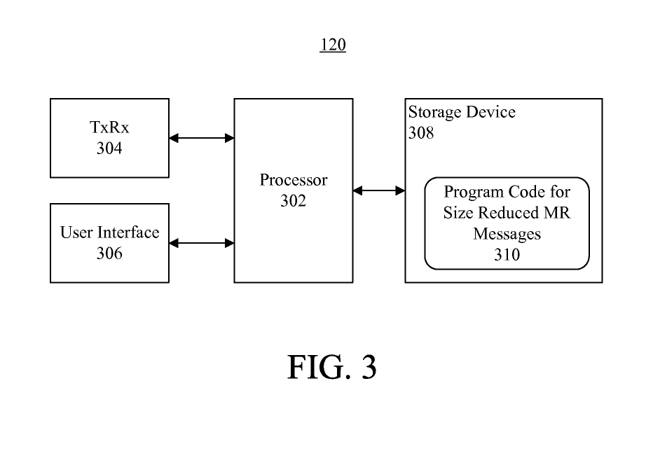

FIG. 3 depicts a block diagram of the communication device 120 that is useful for understanding the present invention. The communication device 120 can include a processor 302 which may comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The communication device 120 also can include a transceiver 304. The transceiver 304 can modulate and demodulate signals to convert signals from one form to another, and can transmit and/or receive such signals over one or more various wireless communication networks. The transceiver 304 can be configured to communicate data via any of a myriad of suitable radio access technologies, and the invention is not limited in this regard.

The communication device 120 further can include a user interface 306. The user interface 306 can comprise, for example, audio input and output devices and corresponding controllers, image and/or video input and output devices and corresponding controllers, tactile input devices and corresponding controllers, haptic output devices and corresponding controllers, and/or the like. In one arrangement, one or more of such controllers can be integrated into the processor 302, though this need not be the case.

The communication device 120 also can include a machine-readable storage device (hereinafter “storage device”) 308. The storage device 308 can include a hard disk drive (HDD), a solid state drive (SSD), a random access memory (RAM), a read-only memory (ROM), an erasable programmable read-only memory (EPROM or Flash memory), an optical storage device, a magnetic storage device, a magneto/optical storage device, or any suitable combination of the foregoing. In the context of this document, a machine-readable storage device may be any tangible data storage device that can contain or store machine-readable program code (hereinafter “program code”) for use by or in connection with an instruction execution system, apparatus, or device.

In this regard, the storage device 308 can have stored thereon program code 310 for generating size reduced MR messages. Specifically, the program code 310 can be executed by the processor 302 to implement the methods and processes described herein to generate the size reduced MR messages. The program code 310 can be implemented as software, firmware, an application, or in any other suitable manner. The storage device 308 further maintains the OOS counter threshold value, and the processor 302 implements OOS counter 150 based on programs and data maintained by storage device 308. However, in another embodiment of the present invention, the OOS counter 150 may be a separate module of the communication device 120.

The transceiver 304, user interface 306 and machine-readable storage device 308 can be communicatively linked to the processor 302 via one or more communication buses, communication ports, or in any other suitable manner. As those skilled in the art will appreciate, the communication device 120 also can include other components (not shown), such as one or more additional transceivers, network adapters, audio processing components, video processing components, etc.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The present invention also can be embedded in a computer-usable medium, such as a computer program product or other data programs storage device, readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

This invention can be embodied in other forms without departing from the spirit or essential attributes thereof. Accordingly, reference should be made to the following claims, rather than to the foregoing specification, as indicating the scope of the invention.

What is claimed is:

1. A method of mitigating a risk of a communication session being dropped while the communication session is in progress, comprising:
generating conventional measurement report (MR) messages and communicating from a mobile communication device to a communication network the conventional MR messages;
responsive to the mobile communication device detecting an out-of-sync (OOS) condition, incrementing an OOS counter;
when the OOS counter is equal to at least a threshold value:
ceasing generation of the conventional MR messages;
generating at least one size reduced MR message, wherein an amount of data contained in the size reduced MR message is selectively limited to be less than an amount of data contained in the conventional MR messages; and
communicating from the mobile communication device to the communication network the size reduced MR message.

2. The method of claim 1, wherein generating the at least one size reduced MR message comprises:
including within the size reduced MR message information corresponding to wireless access nodes having a signal strength, as measured by the mobile communication device, at least equal to a signal strength threshold level; and
excluding from the size reduced MR message information corresponding to wireless access nodes having a signal strength, as measured by the mobile communication device, less than the signal strength threshold level.

3. The method of claim 1, wherein generating the at least one size reduced MR message comprises:
including within the size reduced MR message information corresponding to wireless access nodes having a signal-to-noise (SNR) ratio, as measured by the mobile communication device, at least equal to a SNR threshold level; and
excluding from the size reduced MR message information corresponding to wireless access nodes having a SNR, as measured by the mobile communication device, less than the SNR level.

4. The method of claim 1, wherein generating the at least one size reduced MR message comprises:
detecting a plurality of wireless access nodes available to the mobile communication device to receive handoff of the mobile communication device;
for each wireless access node, determining a signal strength of the wireless access node as measured by the mobile communication device;
ranking the detected wireless access nodes based upon their respective signal strength;
selecting from the detected wireless access nodes a selected number of highest ranked wireless access nodes;
including within the size reduced MR message information corresponding to the highest ranked wireless access nodes; and
excluding from the size reduced MR message information corresponding to wireless access nodes that are not the highest ranked wireless access nodes.

5. The method of claim 1, wherein generating the at least one size reduced MR message comprises:
detecting a plurality of wireless access nodes available to the mobile communication device;
for each wireless access node, determining a signal-to-noise (SNR) ratio of the wireless access node as measured by the mobile communication device;
ranking the detected wireless access nodes based upon their respective SNR;
selecting from the detected wireless access nodes a selected number of highest ranked wireless access nodes;
including within the size reduced MR message information corresponding to the highest ranked wireless access nodes; and
excluding from the size reduced MR message information corresponding to wireless access nodes that are not the highest ranked wireless access nodes.

6. The method of claim 1, wherein the size reduced MR message is an event 1A (E1A) message.

7. The method of claim 1, wherein the size reduced MR message is an event 1C (E1C) message.

8. A mobile communication device, comprising:
a transceiver; and
a processor configured to:
generate conventional measurement report (MR) messages and, via the transceiver, communicate the conventional MR messages to a communication network;
responsive to detecting an out-of-sync (OOS) condition between the mobile communication device and the communication network, increment an OOS counter;
when the OOS counter is equal to at least a threshold value:
cease generation of the conventional MR messages;
generate at least one size reduced MR message, wherein an amount of data contained in the size reduced MR message is selectively limited to be less than an amount of data contained in the conventional MR messages; and
via the transceiver, communicate the size reduced MR message to the communication network.

9. The mobile communication device of claim 8, wherein the at least one size reduced MR message comprises information corresponding to wireless access nodes having a signal strength, as measured by the mobile communication device, at least equal to a signal strength threshold level;
wherein information corresponding to wireless access nodes having a signal strength, as measured by the mobile communication device, less than the signal strength threshold level is excluded from the size reduced MR message.

10. The mobile communication device of claim 8, wherein the at least one size reduced MR message comprises information corresponding to wireless access nodes having a signal-to-noise (SNR) ratio, as measured by the mobile communication device, at least equal to a SNR threshold level;
wherein information corresponding to wireless access nodes having a SNR, as measured by the mobile communication device, less than the SNR level is excluded from the size reduced MR message.

11. The mobile communication device of claim 8, wherein the processor is configured to:
detect a plurality of wireless access nodes available to the mobile communication device to receive handoff of the mobile communication device;
for each wireless access node, determine a signal strength of the wireless access node as measured by the mobile communication device;
rank the detected wireless access nodes based upon their respective signal strength;
select from the detected wireless access nodes a selected number of highest ranked wireless access nodes;
include within the size reduced MR message information corresponding to the highest ranked wireless access nodes; and
exclude from the size reduced MR message information corresponding to wireless access nodes that are not the highest ranked wireless access nodes.

12. The mobile communication device of claim 8, wherein the processor is configured to:
detect a plurality of wireless access nodes available to the mobile communication device;
for each wireless access node, determine a signal-to-noise (SNR) ratio of the wireless access node as measured by the mobile communication device;
rank the detected wireless access nodes based upon their respective SNR;
select from the detected wireless access nodes a selected number of highest ranked wireless access nodes;
include within the size reduced MR message information corresponding to the highest ranked wireless access nodes; and
exclude from the size reduced MR message information corresponding to wireless access nodes that are not the highest ranked wireless access nodes.

13. The mobile communication device of claim 8, wherein the size reduced MR message is an event 1A (E1A) message.

14. The mobile communication device of claim 8, wherein the size reduced MR message is an event 1C (E1C) message.

15. A machine-readable storage device having stored thereon machine-readable program code that, when executed by a system comprising a processor, mitigates a risk of a communication session being dropped while the communication session is in progress, the machine-readable storage device comprising:
machine-readable program code that generates conventional measurement report (MR) messages and communicates from a mobile communication device to a communication network the conventional MR messages;
machine-readable program code that, responsive to the mobile communication device detecting an out-of-sync (OOS) condition, increments an OOS counter;
machine-readable program code that, when the OOS counter is equal to at least a threshold value:
ceases generation of the conventional MR messages;
generates at least one size reduced MR message, wherein an amount of data contained in the size reduced MR message is selectively limited to be less than an amount of data contained in the conventional MR messages; and
communicates from the mobile communication device to the communication network the size reduced MR message.

16. The machine-readable storage device of claim 15, wherein the at least one size reduced MR message comprises information corresponding to wireless access nodes having a signal strength, as measured by the mobile communication device, at least equal to a signal strength threshold level;
wherein information corresponding to wireless access nodes having a signal strength, as measured by the mobile communication device, less than the signal strength threshold level is excluded from the size reduced MR message.

17. The machine-readable storage device of claim 15, wherein the at least one size reduced MR message comprises information corresponding to wireless access nodes having a signal-to-noise (SNR) ratio, as measured by the mobile communication device, at least equal to a SNR threshold level;
wherein information corresponding to wireless access nodes having a SNR, as measured by the mobile communication device, less than the SNR level is excluded from the size reduced MR message.

18. The machine-readable storage device of claim 15, wherein the machine-readable program code that generates the at least one size reduced MR message comprises:
machine-readable program code that detects a plurality of wireless access nodes available to the mobile communication device to receive handoff of the mobile communication device;
machine-readable program code that, for each wireless access node, determines a signal strength of the wireless access node as measured by the mobile communication device;
machine-readable program code that ranks the detected wireless access nodes based upon their respective signal strength;
machine-readable program code that selects from the detected wireless access nodes a selected number of highest ranked wireless access nodes;
machine-readable program code that includes within the size reduced MR message information corresponding to the highest ranked wireless access nodes; and
machine-readable program code that excludes from the size reduced MR message information corresponding to wireless access nodes that are not the highest ranked wireless access nodes.

19. The machine-readable storage device of claim 15, wherein the machine-readable program code that generates the at least one size reduced MR message comprises:
machine-readable program code that detects a plurality of wireless access nodes available to the mobile communication device;
machine-readable program code that, for each wireless access node, determines a signal-to-noise (SNR) ratio of the wireless access node as measured by the mobile communication device;
machine-readable program code that ranks the detected wireless access nodes based upon their respective SNR;
machine-readable program code that selects from the detected wireless access nodes a selected number of highest ranked wireless access nodes;
machine-readable program code that includes within the size reduced MR message information corresponding to the highest ranked wireless access nodes; and
machine-readable program code that excludes from the size reduced MR message information corresponding to wireless access nodes that are not the highest ranked wireless access nodes.

20. The machine-readable storage device of claim 15, wherein the size reduced MR message is an event 1A (E1A) message or an event 1C (E1C) message.
